(19) United States
(12) Patent Application Publication
(10) Pub. No.: US 2002/0126381 A1
(43) Pub. Date: Sep. 12, 2002

(54) Stacks of optical structures and methods and apparatus for making same

(76) Inventors: Seong Woo Suh, Florham Park, NJ (US); Francis M. Mess, Ellicott City, MD (US); Ralph Ebbutt, Baltimore, MD (US); Roy E. Meade, Odenton, MD (US); Peter R. Myers, Nottingham, MD (US)

Correspondence Address: YAFO NETWORKS, INC., 1340 F CHARWOOD RD., HANOVER, MD, 21076, US

(21) Appl. No.: 09/799,236

(22) Filed: Mar. 5, 2001

(51) Int. Cl. G02B 5/30; G02B 27/28

(52) U.S. Cl. 359/494; 359/500

(57) ABSTRACT

Stacked optical structures and methods and apparatus for making them are provided. The stack has a uniform gap between adjacent structures in which (1) a mixture of adhesive and mechanical spacers and (2) an optical filler, or adhesive, is placed. Each stacked optical structure includes at least two optical substructures, each of which has a mating surface. The thickness of the gap is equal to the maximum diameter of the mechanical spacers. The mixture is distributed in the gap away from an optical axis and the optical filler is distributed in the gap such that the optical axis passes through it.

### FIELD OF THE INVENTION

The present invention relates to stacks of optical structures and methods and apparatus for making the same, and more particularly to stacking liquid crystal cells.

### BACKGROUND OF THE INVENTION

Liquid crystal cells (hereinafter, “LCCs”) have been used to control polarization of light, particularly in display devices. Use of LCCs in optical communications is also known, but is limited. For example, Rumbaugh et al. U.S. Pat. No. 4,979,235 employs LCCs as polarization transformers in a matching scheme to minimize the difference between the polarization state of an input signal and a local signal. Also, Clark et al. U.S. Pat. No. 5,005,952 (hereinafter, “Clark”) shows an LCC being used as a polarization transformer for coherent detection. In Clark's case, the LCC is used to match the state of polarization at the output of a transmission fiber to that of a local oscillator beam.

LCCs also have been used in serial combination to form polarization controllers. For example, Asham et al. describes a type of liquid crystal polarization control device that uses nematic liquid crystals (see “A practical liquid crystal polarization controller,” in Proc. ECOC '90, Amsterdam, Vol. 1, at 393-396 (1990)). Sandel et al. also describes deformed-helical ferroelectric LCCs in serial combination to form a polarization controller for compensating Polarization Mode Dispersion (hereinafter, “PMD”) in an optical signal (see “10-Gb/s PMD Compensation Using Deformed-Helical Ferroelectric Liquid Crystals,” Proc. ECOC '98, Madrid, Spain, at 555 (September, 1998)) (hereinafter, “Sandel”).

PMD causes light to propagate at slightly different velocities along two orthogonal directions, thus resulting in a phase delay between the two respective parts. This delay is commonly referred to as Differential Group Delay (hereinafter, “DGD”). Sandal's device uses a highly esoteric liquid crystal material that may be difficult to manufacture and manipulate, and typically has many intrinsic defects.

While these references describe the use of LCCs, no reference, however, describes how, or even if, the individual LCCs are attached to each other. Moreover, none of the references discuss the importance of maintaining signal integrity as it evolves through LCCs, especially stacked LCCs. Optical signals may evolve through LCCs by undergoing a transformation of the optical signal, but effective transformation may be dependant upon LCCs that have low insertion losses and high extinction ratios. High extinction ratios generally provide greater control of the transformation of the optical signal (e.g., the amount of induced DGD) as it evolves through the LCCs.

It would therefore be desirable to provide methods and apparatus for forming a stack of optical structures, such as a stack of LCCs.

It would also be desirable to provide methods and apparatus for forming a stack of optical structures that has a low insertion loss and a high extinction ratio, such that optical signals evolving through the stack does so with minimal optical degradation.

### SUMMARY OF THE INVENTION

It is therefore an object of this invention to provide methods and apparatus for forming a stack of optical structures.

It is also an object of this invention to provide methods and apparatus for forming a stack of optical structures that has a low insertion loss and a high extinction ratio, such that optical signals evolving through the stack does so with minimal optical degradation. In accordance with this invention, methods and apparatus for forming a stack of optical structures are provided. The optical structures that form the optical stack are, in accordance with the present invention, mated to each other with a uniform gap and an optical filler (e.g., optical adhesive) therebetween.

The gap can be maintained, for example, with a mixture that includes an adhesive and a plurality of mechanical spacers. The mixture is distributed on at least one of the mating surfaces in such a way that the mixture does not interfere with the evolution of the optical signal. The optical structures can also be aligned to provide optimal extinction ratios by ensuring, in the case of LCCs, that the rubbing angles are relatively parallel.

An optical stack, in accordance with the present invention, can be constructed such that an optical signal evolves through the interfaces of the stack with minimal loss and degradation. Moreover, when the optical structures have a variable birefringence, the stack can add a controllable amount of DGD to the signal. An optical stacking tool can be used to manufacture the optical stack. The tool can properly align the mating surfaces of the optical structures with an optical filler and an adhesive mixture. This tool provides the proper amount of force to mate the surfaces together to achieve a uniform gap. The tool also allows the optical filler, which can be an adhesive, and the adhesive mixture to cure during the mating procedure.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a perspective view of an illustrative optical structure stack with a flexible printed circuit according to this invention;

FIG. 2 shows a planar view of a circumferential distribution pattern of an adhesive mixture on a mating surface of an optical structure according to this invention;

FIG. 3 shows a planar view of discontinuous sections of an adhesive mixture distributed in a circumferential pattern on a mating surface of an optical structure according to this invention;

FIG. 4 shows a planar view of discontinuous sections of an adhesive mixture distributed in the corners of a mating surface of an optical structure according to this invention;

FIG. 5 shows a planar view of a circular pattern of an optical filler disposed on a mating surface of an optical structure according to this invention;

FIG. 6 shows a planar view of a strip pattern of an optical filler disposed on a mating surface of an optical structure according to this invention;

FIG. 7 shows a planar view of a star pattern of an optical filler disposed on a mating surface of an optical structure according to this invention;

FIG. 8 shows a cross-sectional view of an optical stack with optical filler positioned along the optical axes and adhesive mixture positioned away from the optical axes according to this invention;

FIG. 9 shows a planar view of the optical stack shown in FIG. 8 taken along line 9-9 of FIG. 8, including a distribution of adhesive mixture and optical filler after the two mating surfaces have been pressed together according to this invention;

FIG. 10 shows a perspective view of an illustrative stacking tool for mating the optical stack shown in FIG. 1 according to this invention;

FIG. 11A shows a perspective view of another illustrative embodiment of a stacking tool in an “open” position that can be used to mate the stack shown in FIG. 1 according to this invention; and

FIG. 11B shows a perspective view of the stacking tool of FIG. 11A in a “closed” position according to this invention.

### DETAILED DESCRIPTION OF THE INVENTION

Methods and apparatus for forming a stack of optical structures are provided. In particular, methods and apparatus are provided for forming optical stacks with interfaces between the optical structures, such that the interfaces have a minimal affect on optical signals as they evolve through the stack. The stack can be used as a variable delay device for introducing a controllable amount of DGD to an evolving optical signal.

An optical structure according to this invention includes at least one optical element with a mateable surface (e.g., a substantially flat surface), including a variable birefringence device, such as an LCC. Thus, a stack could include any number of optical structures. The LCCs are preferably aligned and mated together such that low insertion losses and high extinction ratios can be achieved at the interface.

It is known that by applying a voltage to the electrodes of an LCC, the birefringence of that LCC can be actively controlled to any angle. This is because the magnitude of a LCC birefringence is proportional to the amount of induced delay in an optical signal. By using multiple LCCs in a single stack, multiple degrees of freedom for controlling the amount of DGD injected into a signal as it evolves through the optical stack can be achieved. These degrees of freedom, however, can depend upon the quality of the stack in accordance with the principles of the present invention.

The optical stack can be constructed in a number of different ways, but there are some general guidelines that should be used during the construction of any stack according to this invention. For example, when an optical structure (e.g., an LLC) has at least one optical axis, the axis can be normal to a mating surface on the optical structure. When one structure is stacked onto another structure, the mating surfaces of both structures can be parallel to and face each other to form a uniform gap therebetween. It will be appreciated that the relative orientation of the structures to each other can be important for all six translational and rotational axes. For example, the planes of the mating surfaces of each structure should be as parallel as possible. In addition, proper alignment of intrinsic properties (e.g., rubbing angles) of the optical structure can also be important during the mating process. Moreover, the difference of the rubbing angle alignment between each optical structure can be important to obtain high extinction ratios. Finally, the stack should be as optically transmissive as possible.

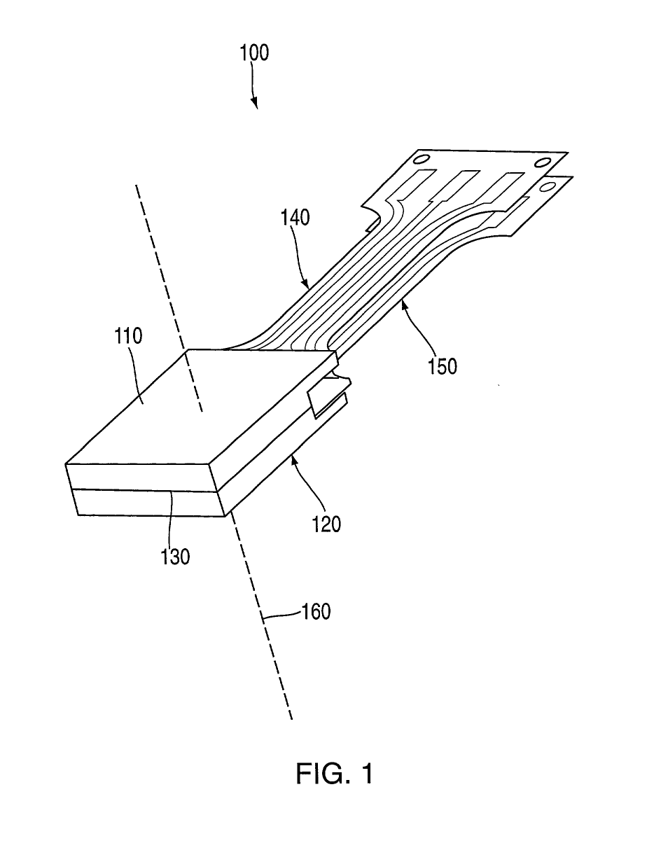

FIG. 1 shows optical stack 100, which includes first optical structure 110 and second optical structure 120. Structures 110 and 120 are aligned with respect to each other such that substantially uniform gap 130 exists between the structures. Structures 110 and 120 can, for example, be liquid crystal cells, or any other optical media having substantially flat surfaces. First, flexible printed circuit 140 can be attached to structure 110 and second flexible printed circuit 150 can be attached to structure 120. Circuits 140 and 150 provide electrically conductive paths for applying voltages to control the birefringent angles associated with each of optical structures 110 and 120.

The material that fills substantially uniform gap 130 can be a combination of: (1) a mixture of optical adhesive and mechanical spacers, and (2) an amount of optical filler (e.g., adhesive) without spacers. Gap 130 is believed to aid in the control of DGD. The mixture can be distributed on the mating surface of structure 110, structure 120, or both structures. The mixture should, however, be distributed away from optical axis 160 of optical structures 110 and 120. In this way, an optical signal will not be significantly degraded. As used herein, the “optical axis” is the path that an optical signal takes as it evolves through the stack. This axis can, for example, be orthogonal to the mating surfaces. Moreover, there may be multiple optical paths through a single optical structure.

The mixture is distributed away from the optical axes so that the optical signal is not reflected, refracted, or otherwise degraded by the mechanical spacers as it evolves through the stack. Thus, the mixture and the optical filler should be distributed such that the optical axes of structures 110 and 120 pass only through the optical filler (i.e., the portion without mechanical spacers).

According to another aspect of the present invention, a single optical stack can process multiple channels of optical signals sequentially or simultaneously. For example, a multiple channel stack can process one optical signal on one optical axis and another optical signal that gets reflected back through the optical stack on different optical axis. Alternatively, multiple optical signals can evolve simultaneously through the stack along separate axes. In either case, the optical axes pass only through the optical filler—not through the mixture.

Persons skilled in the art will appreciate that there are, in accordance with the present inventions, numerous methods for structure-to-structure alignment for forming an optical stack of structures. More particularly, the process of aligning and/or attaching two or more optical structures together can be performed as follows.

Before the structures are placed in physical contact with one another, the mating surfaces of each optical structure should be cleaned, for example, by using a solvent (such as alcohol) to remove any particulate matter, and/or using a plasma cleaner (e.g., a MARCH PX-500) to remove any chemical residues. In addition, the optical structures can be further cleaned to provide optimal signal evolution conditions.

After cleaning, a controlled volume of a mixture made up of an adhesive and a plurality of mechanical spacers are deposited on at least a portion of one mating surface of an optical structure. It will be appreciated that the mixture can be placed on both mating surfaces, if desired. The adhesive in the mixture can be, for example, made from an optical filler that has the same refractive index as the adjacent optical structures to reduce reflections at the interface. Preferably, the adhesive can be a “soft” acrylic material that does not warp or bend the mating surface as the adhesive cures, such as the light curing adhesive sold as model No. OP-24, by the Dymax Corporation, of Torrington, Conn. The adhesive can also be, for example, a thermoset or a thermoplastic.

The mechanical spacers used in the mixture can be glass spheres, such as Accuspheres™, which are sold by MO-SCI Corporation, of Rolla, Mo. These spacers have a maximum diameter between about 1 μm and about 20 μm, but preferably have a maximum diameter between about 5 μm and about 12 μm. For particular applications, including certain LCC stacks, the optimal glass sphere maximum diameter may be around 7 μm. The glass spheres, when mixed with an adhesive, can be deposited strategically on the mating surface so that a gap forms between the two mating surfaces that has a uniform thickness equal to the maximum diameter of the mechanical spacers used. The mechanical spacers can also be fibers having a maximum diameter between about 1 μm and about 20 μm.

Mechanical spacers, and in particular, glass spheres, have been combined with optical adhesive sold by Dymax Corporation under Model No. OP-24 and used to successfully form stacked optical structures with uniform gap thickness. The mixture provides a consistent technique for forming numerous optical stacks by ensuring that the resultant gap has the same substantially uniform thickness.

Moreover, the mixture can be applied with a dispensing machine, such as the Camalot 1818, which uses a time pressure pump, or by a handheld dispenser, such as the EFD-800 Time-Pressure Unit. Persons skilled in the art will appreciate that the mixture can be dispensed in part or in full on either mating surface. Moreover, the mixture need only be disposed in a location that is not in the optical path to avoid interface with mechanical spacers.

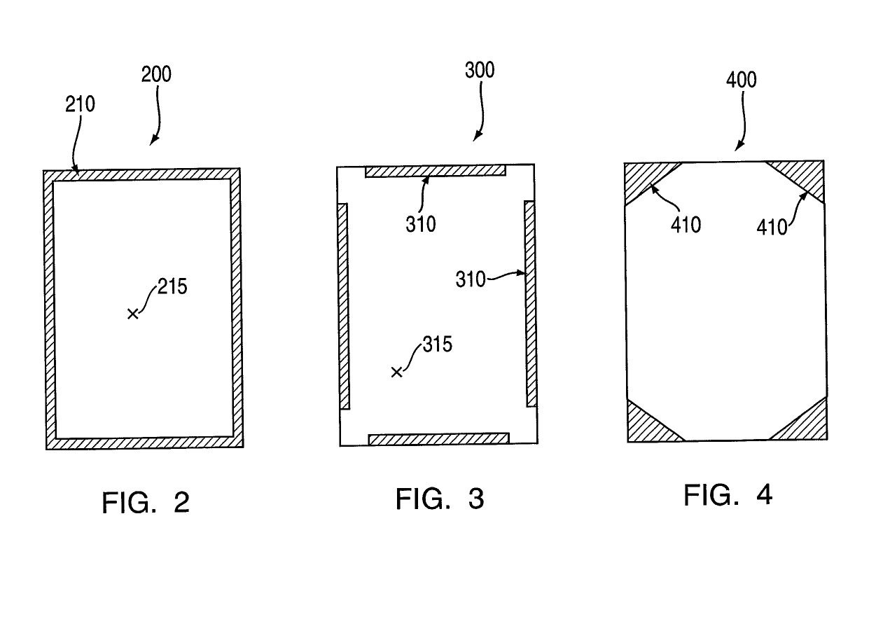

FIG. 2, for example, shows one illustrative embodiment according to this invention in which mixture 210 is distributed in a circumferential pattern on mating surface 200. The optical axis may pass anywhere within the area contained by the circumferential pattern of mixture 210, such as location 215. FIG. 3 shows, for example, another embodiment in which mixture 310 is distributed in a plurality of discontinuous sections about the edges of mating surface 300. As described with respect to FIG. 2, the optical axis may pass anywhere the mixture is not, such as location 315.

FIG. 4 shows another illustrative embodiment in which mixture 410 is distributed near the corners of mating surface 400. This embodiment can be particularly useful for enabling effective evacuation of air from the gap as the mating surfaces are forced together. The advantages of evacuating air from the gap will become more apparent below.

Next, an optical filler (e.g., an adhesive) can be deposited in the center of one or both of the mating surfaces to uniformly fill the remaining space as the two mating surfaces are forced together. The optical filler can have the same material properties as the adhesive in the above-described mixture (in fact, it may be the exact same adhesive, but it need not be). The optical filler can also have substantially the same coefficient of refraction as that of the optical structure to reduce reflections and minimize signal degradation.

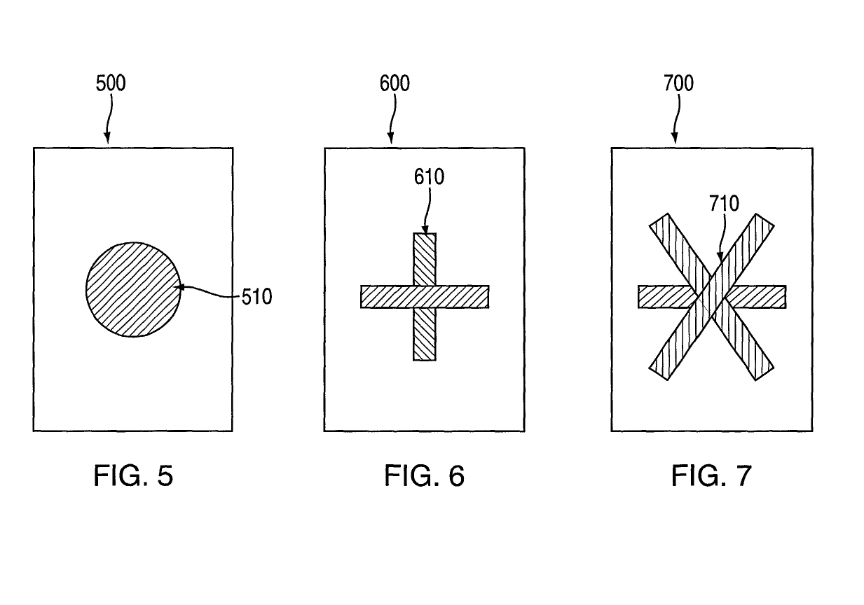

FIG. 5 shows, for example, one embodiment in which optical filler 510 is deposited in a circular pattern on mating surface 500. FIG. 6 shows another embodiment in which optical filler 610 is deposited in a pattern of strips on mating surface 600. FIG. 7 shows yet another embodiment in which optical filler 710 is deposited in a star pattern of strips on mating surface 700. It will be appreciated the pattern of optical filler can be disposed in any other convenient pattern that minimizes air bubbles during mating.

Once the adhesive is deposited, the two optical structures are mated together with a predetermined alignment. For example, the edges may be aligned such that the optical axes have a predetermined orientation with respect to one another. The rubbing angles of each optical structure, for example, may be aligned so that the difference between the rubbing angle of the first optical structure and the rubbing angle of the second optical structure lies between about 0 and about 20 degrees. If a high extinction ratio (e.g., at least a 25 dB extinction ratio) is desired, the difference between the optical structure rubbing angles should be between about 0 and about 3 degrees.

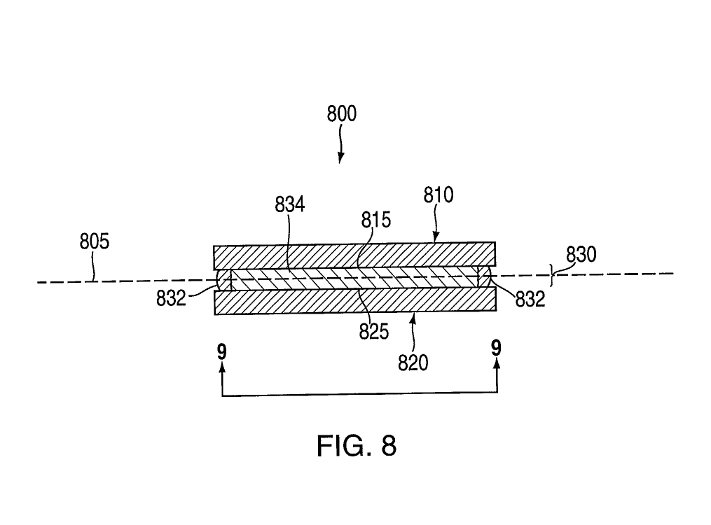

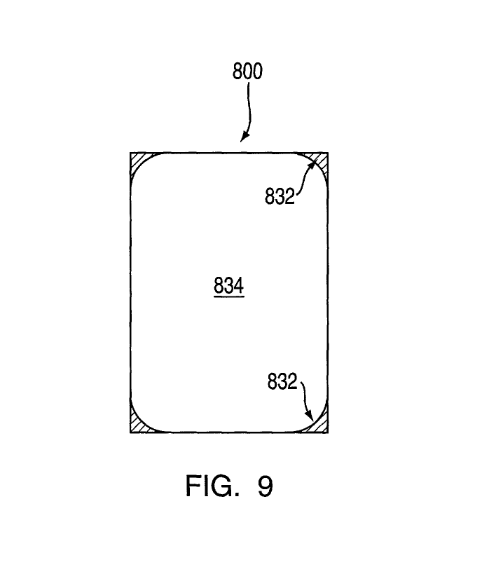

FIG. 8 shows a cross sectional view of optical stack 800, which includes first optical structure 810 and second optical structure 820, separated by gap 830. By viewing along plane 805 of gap 830, the arrangement of mixture 832 and optical filler 834, both of which adhere to surfaces 815 and 825 is apparent. In particular, mixture 832 can be distributed on the edges of gap 830 while optical filler 834 fills the remaining volume of gap 830. The edges of first optical structure 810 are aligned with the edges of second optical structure 820 to form optical stack 800. It will be appreciated that the alignment could be different as desired.

A moderate force can be applied to drive first mating surface 815 and second mating surface 825 together. The force can be applied until gap 830 between the two surfaces is substantially equal to the maximum diameter of the mechanical spacers in mixture 832. During this process, optical filler 834 and mixture 832 are compressed from the applied force, which causes them to spread out and substantially fill gap 830. As optical filler 834 squeezes, air inside gap 830 may be pushed out of gap 830 such that substantially no air bubbles form in the optical path. Air bubbles distort the evolving optical signal and are therefore preferably avoided. FIG. 8, for example, shows how mixture 832 and optical filler 834 can be distributed after the mating surfaces have been pressed together such that substantially no air bubbles exist between the surfaces.

After the two plates have been forced together, either the optical filler, mixture, or both may be cured, so that the optical structures are permanently attached to one another to form the optical stack. The optical filler and the mixture can be cured, for example, by the application of light, such as blue light, ultra-violet light, or any other suitable light. Curing may also occur from the application of heat, such as from an oven, an iron, or a heat gun.

Another way to attach optical structures together having a fixed uniform gap between them may involve applying the filler to one edge at an elevated temperature to fill the gap via capillary action. Such capillary action is employed by placing the optical filler at one edge of the gap and allowing it to flow into the gap. It is believed that the filler molecules flow because they have a certain affinity for the substrates and for their neighboring molecules. As the filler flows, however, undesirable bubbles (i.e., defects) sometimes form at the interface with the substrate. This has been found to be especially true when the filler is viscous.

Bubble formation due to trapped air, however, should be prevented and a uniform cross-section should be maintained along the optical path. Moreover, other contaminants, such as dust or particulates, should be kept out of the adhesive because they tend to disperse the optical signal and degrade the performance of the device.

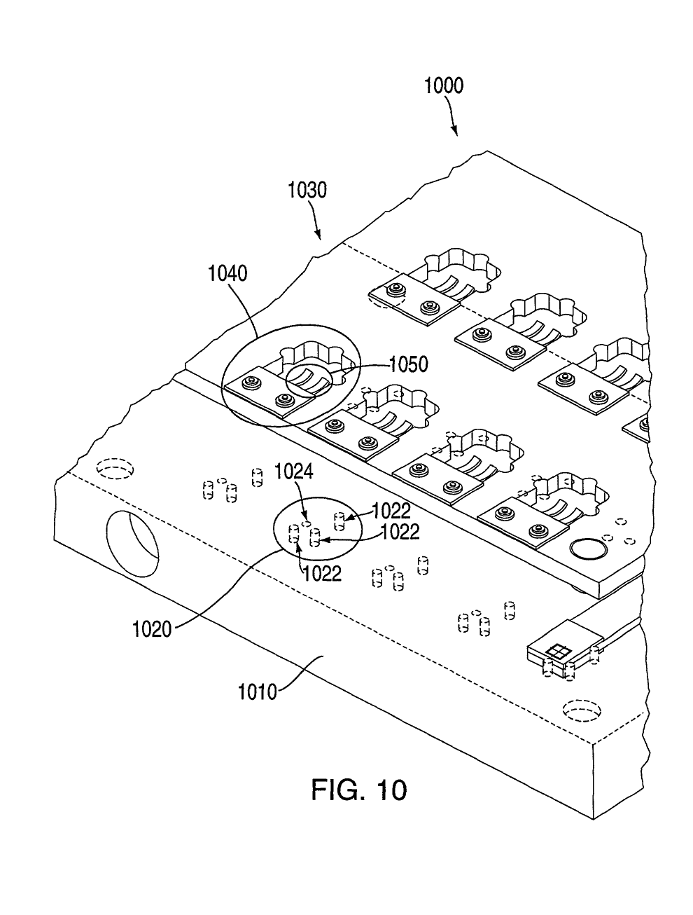

Throughout the assembly process, an optical structure stacking tool can be used to aid in the formation of optical stacks. FIG. 10 shows a partial perspective view, for example, of one embodiment of optical structure stacking tool 1000 having base plate 1010 and clamping structure 1030, which may be used to assemble one or more stacks at the same time. Base plate 1010 has at least one support assembly 1020 for receiving a first optical structure so that the structure can be oriented properly during stacking. Support assembly 1020 can, for example, include an arrangement of posts 1022 to align the first optical structure in support assembly 1020. Support assembly 1020 can also have through hole 1024 so that vacuum may be applied to the first optical structure to hold it in place during the stacking process.

Clamping structure 1030 has at least one top plate 1040 for applying a force to the optical stack to force the gap thickness between the two mating surfaces to be substantially equal to the maximum thickness of the mechanical spacers. Top plate 1040 can be made from a translucent material or have a hole that allows light to pass through it to cure the optical filler and/or mixture. As shown in FIG. 10, top plate 1040 can be applied to each optical stack simultaneously by force application mechanism 1050. Mechanism 1050 can be a mechanism, such as a spring-loaded mechanism, a latch mechanism, a magnetic mechanism, or any other suitable mechanism that can squeeze at least two optical structures together.

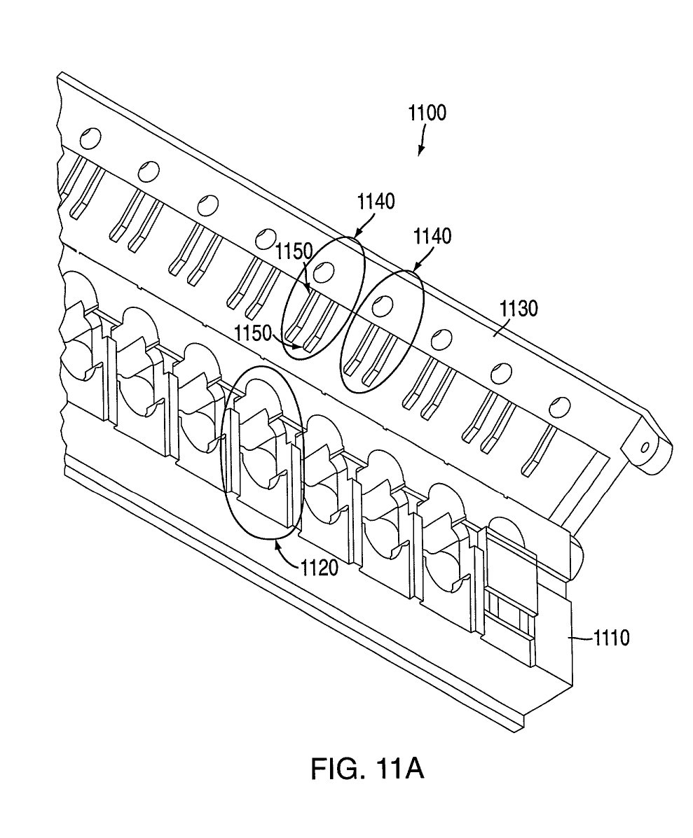

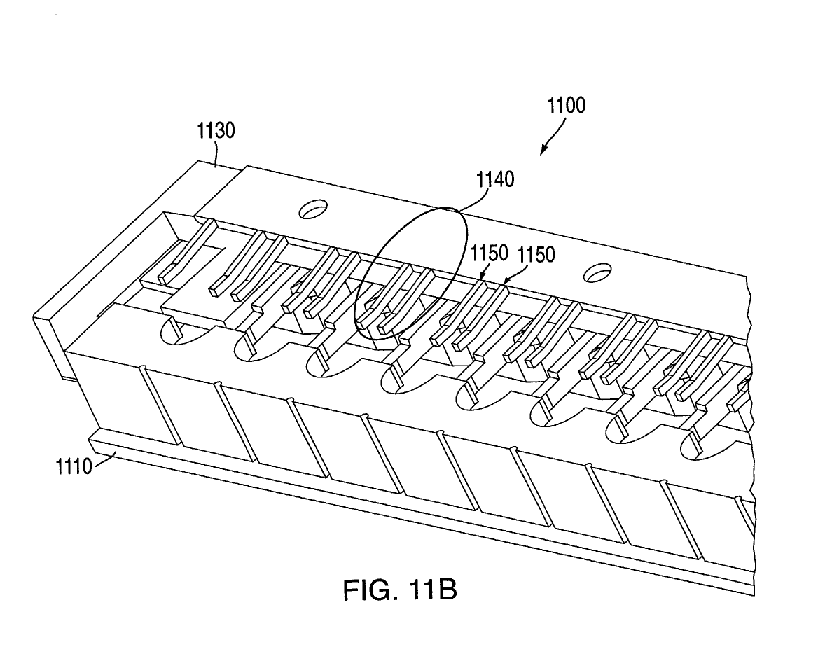

FIG. 11A shows a perspective view of a partial section of another embodiment of optical structure stacking tool 1100, which includes base 1110 and clamping structure 1130 in the “open” position. Base 1110 has support assemblies 1120, each of which can receive a first optical structure for alignment with a second optical structure. Support assemblies 1120 can be designed as shown to prevent the first structure from shifting as the second structure is mated to the first structure. During the mating process, excess adhesive may seep from the edge of the gap of an optical structure stack before the adhesive cures. The design of support assembly 1120 prevents any accidental adhesion of the newly cured optical stack to stacking tool 1100.

Clamping structure 1130 can have a plurality of top plates 1140 that can be used to hold the optical stacks between base plate 1110 and top plate 1140. FIG. 11A shows clamping structure 1130 in the “open” position that is, one or more optical structures can be inserted into each support assembly 1120. Top plate 1140 can have force mechanism 1150 that presses the optical structures together, forming a substantially uniform gap thickness that is equal to the maximum diameter of the mechanical spacers. As discussed above, force mechanism 1150, for example, can be a spring-loaded mechanism, a magnetic mechanism, a latch mechanism, or any combination thereof.

FIG. 11B shows another perspective view of optical structure stacking tool 1100 in the “closed” position. The closed position shows how each force mechanism 1150 applies a force to an optical stack. Top plate 1140 has force mechanisms 1150 that allow sufficient passage of light, which may be used to cure the adhesive being squeezed in the gap. This embodiment also shows that each top plate 1140 is applied to the optical stacks simultaneously. This, however, need not be the case. It will be appreciated, for example, that a stacking tool can be used to apply individual top plates 1140 to individual optical structures.

Persons skilled in the art will appreciate that the present invention can be practiced by other than the described embodiments, which are presented for purposes of illustration and not of limitation. It will be further appreciated that the present invention is limited only by the claims that follow.

What is claimed is:

1. An optical stack having at least one optical axis along which an optical signal can pass, said stack comprising:
a first optical structure having at least a first mating surface;
a second optical structure having at least a second mating surface, wherein said first and second surfaces face each other to form a substantially uniform gap therebetween;
a mixture comprising an adhesive and a plurality of mechanical spacers having a maximum diameter substantially equal to said gap, wherein said mixture is distributed in said gap and away from said optical axis; and
an optical filler distributed in said gap such that said optical axis passes primarily through said optical filler.

2. The stack of claim 1 wherein at least one of said optical structures is a birefringent medium.

3. The stack of claim 2 wherein said birefringent medium comprises at least one liquid crystal structure.

4. The stack of claim 3 wherein said at least one liquid crystal structure further comprises a flexible printed circuit.

5. The stack of claim 1 wherein said mixture adhesive and said optical filler are the same.

6. The stack of claim 1 wherein at least one of said mixture adhesive and said optical filler comprises a light-curing adhesive.

7. The stack of claim 1 wherein at least one of said mixture adhesive and said optical filler comprises a soft acrylic adhesive.

8. The stack of claim 1 wherein said mixture has a distribution pattern comprising a circumferential portion distributed near at least one edge of said gap.

9. The stack of claim 8 wherein said circumferential portion comprises a plurality of discontinuous sections.

10. The stack of claim 9 wherein at least one of said plurality of discontinuous sections is placed near a corner of said gap.

11. The stack of claim 1 wherein said gap comprises a substantially cured combination of said mixture and said optical filler.

12. The stack of claim 1 wherein said mechanical spacers comprises a plurality of glass sphere having a maximum diameter between about 1 μm and about 20 μm.

13. The stack of claim 12 wherein said maximum diameter is between about 5 μm and about 12 μm.

14. The stack of claim 13 wherein said maximum diameter is about 7 μm.

15. The stack of claim 1 wherein said mechanical spacers comprises at least one glass fiber with a maximum diameter of between 1 μm and about 20 μm.

16. The stack of claim 1 wherein said at least one optical axis comprises a plurality of optical axes for optically processing multiple channels, and wherein said mixture is distributed away from each of said axes and said optical filler is distributed such that said optical axes pass through only said optical filler.

17. A method for stacking at least two optical structures having an optical axis along which an optical signal can evolve, said method comprises:
cleaning at least one substantially flat mating surface of said structures;
disposing a mixture on at least a first of said mating surfaces in a pattern such that said optical axis does not pass through said mixture, said mixture comprising an adhesive and a plurality of mechanical spacers having a maximum diameter;
disposing an optical filler on at least one of said mating surfaces such that said optical axis passes through said optical filler;
mating said surfaces such that a gap is formed between said surfaces having a thickness that is substantially the same as said maximum diameter; and
curing said mixture and said optical filler.

18. The method of claim 17 wherein said cleaning comprises a method selected from a group consisting of applying an alcoholic solvent to said mating surfaces, plasma cleaning said mating surfaces, and a combination thereof.

19. The method of claim 17 wherein said disposing said mixture comprises disposing a circumferential portion near at least one edge of at least one of said mating surfaces.

20. The method of claim 19 wherein said circumferential portion comprises a plurality of discontinuous sections disposed on at least one of said mating surfaces.

21. The method of claim 20 wherein said at least one of said plurality of discontinuous sections is disposed near a corner of at least one of said mating surfaces.

22. The method of claim 17 wherein said disposing said optical filler comprises a portion disposed on at least one of said mating surfaces.

23. The method of claim 22 wherein said portion comprises a method selected from a group consisting of disposing a circular pattern, a strip pattern, a star pattern, and a combination thereof, said pattern disposed on at least one of said mating surfaces.

24. The method of claim 17 wherein said mating comprises evacuating substantially all air from said gap upon said mating of said surfaces such that substantially no air bubbles form between said surfaces.

25. The method of claim 17 wherein said mating comprises aligning said mating surfaces substantially in parallel such that said signal can evolve through substantially collinear axes.

26. The method of claim 17 wherein said mating comprises aligning at least one edge of said first mating surface to at least one edge of another said mating surface so that said structures are substantially stacked.

27. The method of claim 17 wherein said mating comprises aligning a first rubbing angle of a first said optical structure with a second rubbing angle of a second said optical structure such that said first rubbing angle and said second rubbing angle are substantially parallel to each other when said first structure is mated to said second structure.

28. The method of claim 17 wherein said curing comprises applying a light to said mixture and said optical filler.

29. An optical structure stacking tool for attaching at least a first optical structure to a second optical structure to form at least one stack, wherein said tool comprises:
a base plate having at least one support assembly adapted to receive said first structure for aligning said first structure with said second structure during stacking; and
a clamping structure mechanically coupled to said base plate, wherein said clamping structure comprises at least one top plate for clamping said first and second optical structures between said top plate and said base plate, and wherein at least one of said base plate and said top plate provide optical access to said optical structures.

30. The stacking tool of claim 29 wherein said support assembly comprises at least two posts for aligning said first structure with said second structure during stacking.

31. The stacking tool of claim 29 wherein said support assembly comprises at least one through hole for a vacuum that secures said first structure to said base plate.

32. The stacking tool of claim 29 wherein said top plate comprises a translucent top plate.

33. The stacking tool of claim 32 wherein said clamping structure comprises a force applicator that clamps said first and second optical structures between said top plate and said base plate.

34. The stacking tool of claim 33 wherein said force applicator comprises a mechanism selected from a group consisting of a spring loaded mechanism, a magnetic mechanism, a latch mechanism, and a combination thereof.

35. The stacking tool of claim 29 wherein said at least one stack comprises a plurality of stacks, and wherein said at least one top plate comprises a plurality of top plates that can each apply pressure to one of said plurality of stacks.
